(19) United States
(12) Patent Application Publication
(10) Pub. No.: US 2023/0223643 A1
(43) Pub. Date: Jul. 13, 2023

(54) SECONDARY BATTERY

(71) Applicant: Samsung SDI Co., Ltd., Yongin-si (KR)

(72) Inventors: Shin Jung KIM, Yongin-si (KR); Dae Kyu KIM, Yongin-si (KR); Jong Jun PARK, Yongin-si (KR)

(21) Appl. No.: 18/151,400

(22) Filed: Jan. 6, 2023

(30) Foreign Application Priority Data
Jan. 7, 2022 (KR) 10-2022-0002680

(51) Int. Cl. H01M 50/342; H01M 50/107; H01M 50/152

(52) U.S. Cl. CPC H01M 50/3425; H01M 50/107; H01M 50/152; H01M 2200/20

(57) ABSTRACT

A secondary battery includes: a cylindrical case; an electrode assembly in the cylindrical case; and a cap assembly configured to seal the cylindrical case and including a cap-down electrically connected to the electrode assembly, a cap-up coupled to an upper portion of the cap-down, and a vent plate between the cap-down and the cap-up, wherein the vent plate includes: a first plate; and a second plate coupled to the outside of the first plate, wherein the first plate has rigidity less than that of the second plate.

### CROSS-REFERENCE TO RELATED APPLICATION

This application claims priority to and the benefit of Korean Patent Application No. 10-2022-0002680 filed in the Korean Patent Office on Jan. 7, 2022, the entire content of which is incorporated herein by reference.

### BACKGROUND

### 1. Field

Aspects of some embodiments relate to a secondary battery.

### 2. Description of the Related Art

Lithium ion secondary batteries may be used, for example, as power sources for hybrid or electric vehicles as well as portable electronic devices because of their generally a high operating voltage and relatively high energy density per unit weight.

Such secondary batteries may have various shapes including, for example, cylindrical, prismatic, and pouch-type secondary batteries. For example, a cylindrical secondary battery generally includes a cylindrical case, a cylindrical electrode assembly coupled to the case, an electrolyte (optional) injected into the case to enable movement of lithium ions, and a cap assembly coupled to one side of the case to prevent or reduce leaking of the electrolyte and prevent or reduce separation of the electrode assembly.

The above information disclosed in this Background section is only for enhancement of understanding of the background and therefore the information discussed in this Background section does not necessarily constitute prior art.

### SUMMARY

Aspects of some embodiments of the present disclosure include a secondary battery that may be capable of maintaining effective venting properties while preventing or reducing deformation when an internal pressure of a case increases.

According to some embodiments, a secondary battery includes: a cylindrical case; an electrode assembly accommodated in the cylindrical case; and a cap assembly configured to seal the cylindrical case and constituted by a cap-down electrically connected to the electrode assembly, a cap-up coupled to an upper portion of the cap-down, and a vent plate interposed between the cap-down and the cap-up, wherein the vent plate includes: a first plate; and a second plate coupled to the outside of the first plate, wherein the first plate has rigidity less than that of the second plate.

According to some embodiments, the first plate may have a thickness less than that of the second plate.

According to some embodiments, the first plate and the second plate may be made of the same material.

According to some embodiments, the first plate and the second plate may be made of materials different from each other, respectively.

According to some embodiments, the first plate may include: a central part in which a notch is provided; a first bent part extending upward from the central part; and an extension part extending outward from the first bent part.

According to some embodiments, the second plate may include: a coupling part in which a coupling groove, in which the extension part is seated, is defined; a second bent part extending upward from the coupling part; and a fixing part extending inward from the second bent part to cover a top surface of the cap-up.

According to some embodiments, the extension part may be interposed between a bottom surface of the cap-up and a top surface of the second plate.

According some embodiments, a secondary battery includes: a cylindrical case; an electrode assembly accommodated in the cylindrical case; and a cap assembly configured to seal the cylindrical case and constituted by a cap-down electrically connected to the electrode assembly, a cap-up coupled to an upper portion of the cap-down, and a vent plate interposed between the cap-down and the cap-up, wherein the vent plate has rigidity less than that of the cap-down.

According to some embodiments, the vent plate may have a thickness less than that of the cap-down.

According to some embodiments, the vent plate and the cap-down may be made of the same material.

According to some embodiments, the vent plate and the cap-down may be made of materials different from each other, respectively.

According to some embodiments, the vent plate may include: a central part in which a notch is provided; a first bent part extending upward from the central part; and an extension part extending outward from the first bent part.

According to some embodiments, the cap-down may include: a first coupling part which is in contact with the central part and in which a plurality of through-holes are provided; a second coupling part which extends outward from the first coupling part and in which a coupling groove, in which the extension part is seated, is provided; a second bent part extending upward from the second coupling part; and a fixing part extending inward from the second bent part to cover a top surface of the cap-up.

### BRIEF DESCRIPTION OF THE DRAWINGS

The accompanying drawings are included to provide a further understanding of embodiments according to the present disclosure, and are incorporated in and constitute a part of this specification. The drawings illustrate aspects of some embodiments of the present disclosure and, together with the description, serve to explain characteristics of some embodiments of the present disclosure. In the drawings:

FIG. 1 is a perspective view illustrating a secondary battery according to some embodiments;

FIG. 2 is a cross-sectional view illustrating the secondary battery according to some embodiments;

FIG. 3 is a cross-sectional view illustrating a cap assembly in the secondary battery according to some embodiments;

FIG. 4 is an enlarged cross-sectional view illustrating a portion A of FIG. 3 according to some embodiments;

FIG. 5 is a cross-sectional view illustrating a state in which a vent plate operates according to some embodiments;

FIG. 6 is a cross-sectional view illustrating a cap assembly according to some embodiments; and

FIG. 7 is an enlarged cross-sectional view illustrating a portion B of FIG. 6.

### DETAILED DESCRIPTION

Hereinafter, aspects of some embodiments will be described in more detail with reference to the accompanying drawings.

Embodiments according to the present inventions may, however, be embodied in many different forms and should not be construed as being limited to the embodiments set forth herein; rather, these embodiments are provided so that those skilled in the art thoroughly understand the present invention. Rather, these embodiments are provided so that this disclosure will be thorough and complete, and will more fully convey the scope of embodiments according to the present invention to those skilled in the art.

In addition, in the following drawings, the thickness or size of each layer is exaggerated for convenience and clarity of description, and the same reference numerals in the drawings refer to the same elements. As used herein, the term “and/or” includes any and all combinations of one or more of the associated listed items. In this specification, it will also be understood that when a member A is referred to as being connected to a member B, the member A can be directly connected to the member B or indirectly connected to the member B with a member B therebetween.

The terms used herein are for illustrative purposes of the present invention only and should not be construed to limit the meaning or the scope of the present invention. As used in this specification, a singular form may, unless definitely indicating a particular case in terms of the context, include a plural form. Also, the expressions “comprise” and/or “comprising” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is obvious that the members, components, areas, layers, and/or portions should not be defined by these terms. The terms do not mean a particular order, up and down, or superiority, and are used only for distinguishing one member, component, area, layer, or portion from another member, component, area, layer, or portion. Thus, a first member, component, area, layer, or portion which will be described may also refer to a second member, component, area, layer, or portion, without departing from the spirit and scope of embodiments according to the present invention.

Spatially relative terms, such as “below”, “beneath”, “lower”, “above”, “upper” and the like, may be used herein for ease of description to describe one element or feature's relationship to another element(s) or feature(s) as illustrated in the figures. These spatially relative terms are intended for easy comprehension of the present invention according to various process states or usage states of the present invention, and thus, the present invention is not limited thereto. For example, an element or feature shown in the drawings is turned inside out, the element or feature described as “beneath” or “below” may change into “above” or “upper”. Thus, the term “below” may encompass the term “above” or “below”.

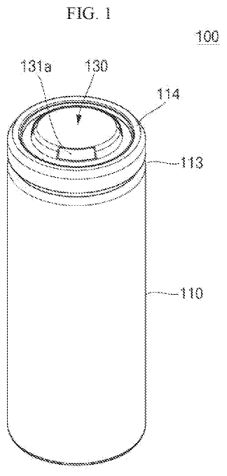

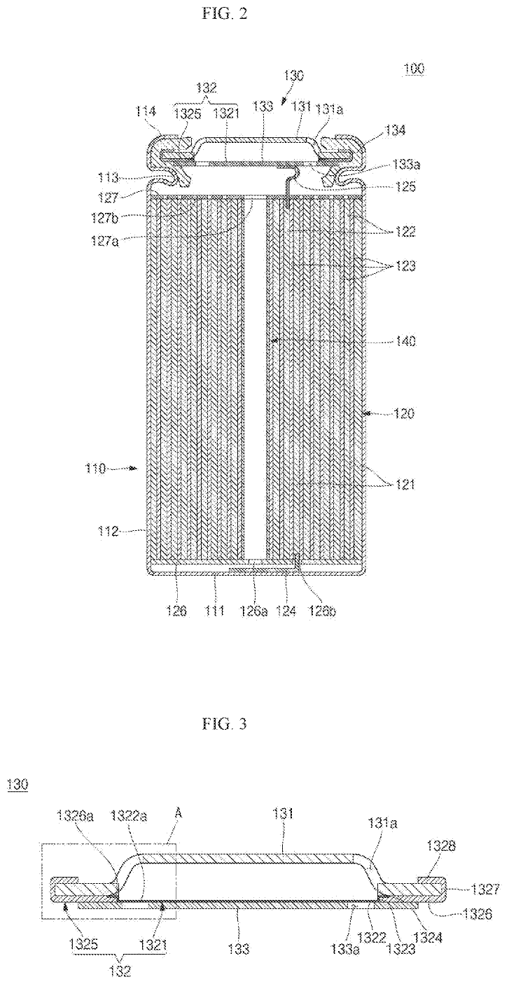

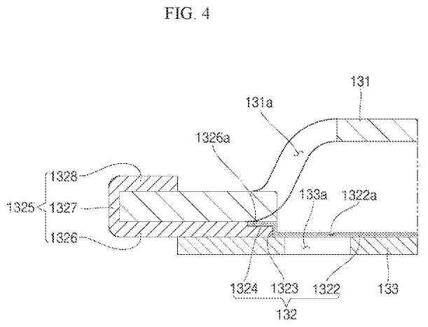

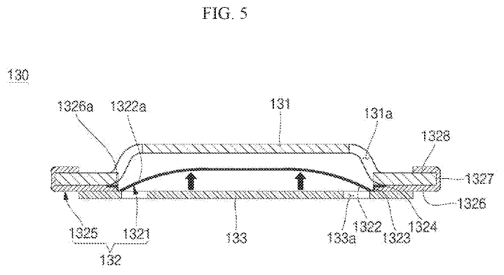

FIG. 1 is a perspective view illustrating a secondary battery according to some embodiments. FIG. 2 is a cross-sectional view illustrating the secondary battery according to some embodiments. FIG. 3 is a cross-sectional view illustrating a cap assembly in the secondary battery according to some embodiments. FIG. 4 is an enlarged cross-sectional view illustrating a portion A of FIG. 3 according to some embodiments. FIG. 5 is a cross-sectional view illustrating a state in which a vent plate operates according to some embodiments.

Referring to FIGS. 1 and 2, a secondary battery 100 according to some embodiments may include a cylindrical case 110, an electrode assembly 120, and a cap assembly 130. According to some embodiments, the cap assembly 130 may include or be referred to as a cap, a cap group, cap assembly, a cover, or lid according to some embodiments.

The cylindrical case 110 may include an approximately circular bottom part 111 and a sidewall 112 extending by a predetermined length upward from the bottom part 111. According to some embodiments, the cylindrical case 110 may include or be referred to as a can, an exterior, or a housing.

During a process of manufacturing the secondary battery, an upper portion of the cylindrical case 110 may be opened. Therefore, during a process of assembling the secondary battery, the electrode assembly 120 may be integrated into one structure and inserted into the cylindrical case 110. Alternatively, thereafter, an electrolyte may be additionally injected into the cylindrical case 110.

The cylindrical case 110 may be made of steel, a steel alloy, nickel-plated steel, a nickel-plated steel alloy, aluminum, or an aluminum alloy.

Furthermore, in the cylindrical can 110, a beading part 113 recessed inward may be provided at a lower portion of the cylindrical can 110 with respect to the cap assembly 130 to prevent or reduce separation of the cap assembly 130 to the outside, and a crimping part 114 bent inward may be provided at an upper portion of the cylindrical can 110 with respect to the cap assembly 130.

The electrode assembly 120 may be accommodated in the cylindrical case 110. According to some embodiments, the electrode assembly 120 may include or be referred to as an electrode, an electrode group, or a jelly roll. The electrode assembly 120 may include a negative electrode plate 121 coated with a negative electrode active material (e.g., graphite, carbon, etc.), a positive electrode plate 122 coated with a positive electrode active material (e.g., transition metal oxide (LiCoO₂, LiNiO₂, LiMn₂O₄, etc.)), and a separator 123 located between the negative electrode plate 121 and the positive electrode plate 122 to prevent or reduce instances of a short circuit occurring and allowing lithium ions to move only. The negative electrode plate 121, the positive electrode plate 122, and the separator 123 may be wound in a substantially cylindrical shape. According to some embodiments, the negative electrode plate 121 may be a copper (Cu) foil, the positive electrode plate 122 may be an aluminum (Al) foil, and the separator 123 may be polyethylene (PE) or polypropylene (PP).

In addition, a negative electrode tab 124 protruding to extend downward by a predetermined length may be welded to the negative electrode plate 121, and a positive electrode tab 125 protruding to extend upward by a predetermined length may be welded to the positive electrode plate 122. In addition, the negative electrode tab 124 may be made of copper (Cu) or nickel (Ni), and the positive electrode tab 125 may be made of aluminum (Al).

Also, the negative electrode tab 124 of the electrode assembly 120 may be welded to the bottom part 111 of the cylindrical case 110. Thus, the cylindrical case 110 may operate as a negative electrode. According to some embodiments, the negative electrode tab 124 may be ultrasonically or laser welded to the bottom part 111 of the cylindrical case 110. Alternatively, on the contrary, the positive electrode tab 125 may be welded to the bottom part 111 of the cylindrical can 110, and in this case, the cylindrical case 110 may operate as a positive electrode.

Furthermore, a first insulating plate 126 coupled to the cylindrical case 110 and having a first hole 126a at a center thereof and a second hole 126b defined in the outside thereof may be interposed between the electrode assembly 120 and the bottom part 111. According to some embodiments, the first insulating plate 126 may serve to prevent or reduce instances of the electrode assembly 120 being in electrical contact with the bottom part 111 of the cylindrical can 110. According to some embodiments, the first insulating plate 126 may serve to prevent or reduce instances of the positive electrode plate 122 of the electrode assembly 120 being in electrical contact with the bottom part 111. According to some embodiments, the first hole 126a may serve to allow a gas to quickly move upward through a center pin 140 when a large amount of gas is generated due to abnormality in the secondary battery, and the second hole 126b may serve to allow the negative electrode tab 124 to pass therethrough so as to be welded to the bottom part 111.

In addition, a second insulating plate 127 coupled to the cylindrical case 110 and having a first hole 127a at a center thereof and a plurality of second holes 126b defined in the outside thereof may be interposed between the electrode assembly 120 and the bottom part 111. The second insulating plate 127 may serve to prevent or reduce instances of the electrode assembly 120 being in electrical contact with the cap assembly 130. According to some embodiments, the second insulating plate 127 may serve to prevent or reduce instances of the negative electrode plate 121 of the electrode assembly 120 being in electrical contact with the cap assembly 130. According to some embodiments, the first hole 127a may serve to allow a gas to quickly move to the cap assembly 130 when a large amount of gas is generated due to abnormality in the secondary battery, and the second hole 126b may serve to allow the positive electrode tab 125 to pass therethrough so as to be welded to the cap assembly 130. In addition, the remaining second hole 127b serves to allow the electrolyte to quickly flow into the electrode assembly 120 during a process of injecting the electrolyte.

In addition, each of the first holes 126a and 127a of the first and second insulating plates 126 and 127 may have a diameter less than that of the center pin 140 so that the center pin 140 is not in electrical contact with the bottom part 111 of the cylindrical case 110 or the cap assembly 130 by an external impact.

The center pin 140 may have a hollow circular pipe shape and may be coupled to the approximately center of the electrode assembly 120. The center pin 140 may be made of steel, stainless steel, aluminum, an aluminum alloy, or polybutylene terepthalate, but the material thereof is not limited thereto. The center pin 140 serves to suppress deformation of the electrode assembly 120 during charging and discharging of the secondary battery and serves as a passage for a gas generated inside the secondary battery. In some cases, the center pin 140 may be omitted.

The cap assembly 130 may seal an opening of the cylindrical case 110 to protect the electrode assembly 120 against the external environment, and when the internal pressure of the cylindrical case 110 is higher than a reference pressure, the cap assembly 130 may be broken to release an internal gas of the cylindrical case 110 to the outside. According to some embodiments, the cap assembly 130 may serve as a positive electrode terminal.

Referring to FIGS. 2 to 4, the cap assembly 130 may include a cap-up 131 provided with a plurality of through-holes 131a, a vent plate 132 installed under the cap-up 131, and a cap-down 133 installed under the vent plate 132 to provide a plurality of through-holes 133a. According to some embodiments, the cap assembly 130 may further include an insulating gasket 134.

A central portion of the cap-up 131 may protrude upward to serve as a terminal electrically connected to an external device. The plurality of through-holes 131a provided in the cap-up 131 may serve to discharge an internal gas to the outside when an abnormal internal pressure occurs due to overcharging or the like inside the cylindrical case 110. According to some embodiments, the cap-up 131 may include or be referred to as a cap, a conductor plate, a cover, or a lid. According to some embodiments, the cap-up 131 may be made of aluminum or an aluminum alloy.

The vent plate 132 may be located under the cap-up 131. According to some embodiments, the vent plate 132 may be in close contact with, in contact with, coupled to, or connected to a lower portion of the cap-up 131. For example, the vent plate 132 may be in close contact with, in contact with, be coupled to, or connected to an edge of the cap-up 131. According to some embodiments, the vent plate 132 may include or be referred to as a safety vent, a safety plate, a vent, a valve, a thin plate, or a conductor plate.

The vent plate 132 may include a first plate 1321 that is substantially flat and located at a center thereof, and a second plate 1325 located outside the first plate 1321. According to some embodiments, the first plate 1321 may be provided at a position corresponding to the central portion protruding upward from the cap-up 131, and the second plate 1325 may be provided at a position corresponding to the edge of the cap-up 131.

A thickness of the first plate 1321 may be provided to be less than that of the second plate 1325. Also, rigidity of the first plate 1321 may be less than that of the second plate 1325.

According to some embodiments, the first plate 1321 and the second plate 1325 may include the same material. According to some embodiments, each of the first plate 1321 and the second plate 1325 may include aluminum. Here, the first plate 1321 may include soft aluminum, and the second plate 1325 may include rigid aluminum. According to some embodiments, the first plate 1321 may include rigid aluminum, and the second plate 1325 may include super-rigid aluminum. For example, the first plate 1321 may include Al 1050, Al 3003, and Al 3005, and the second plate 1325 may include Al 5052 and Al 6000. As described above, when the first plate 1321 and the second plate 1325 are made of the same material, the first plate 1321 and the second plate 1325 may be coupled to each other by welding. According to some embodiments, the first plate 1321 may be ultrasonically and/or laser welded to the second plate 1325.

According to some embodiments, the first plate 1321 and the second plate 1325 may include different materials. For example, the first plate 1321 may include aluminum, and the second plate 1325 may include SUS. As described above, when the first plate 1321 and the second plate 1325 are made of different materials, the first plate 1321 and the second plate 1325 may be coupled to each other by fusion.

The first plate 1321 may include a substantially flat central part 1322, a first bent part 1323 bent and extending upward at an approximately 90 degrees from the central part 1322, and an extension part 1324 bent and extending outward at approximately 90 degrees from the first bent part 1323.

According to some embodiments, thicknesses of the central part 1322, the first bent part 1322, and the extension part 1324 may be substantially similar to or the same as each other. The central part 1322 may further include a notch 1322a provided at a predetermined depth on a top surface thereof. The notch 1322a may be provided at a position corresponding to the through-hole 133a of the cap-down 133.

As illustrated in FIG. 5, when the internal pressure of the secondary battery is greater than the reference pressure (or a breaking pressure of the vent plate), the central part 1322 may be convexly deformed upward by the internal gas. Thereafter, since the notch 1322a provided at the central part 1322 is broken, the internal gas of the cylindrical case 110 may be discharged to the outside through the through-hole 131a of the cap-up 131 to secure safety of the secondary battery.

The first bent part 1323 may be in contact with a side surface of the second plate 1325, and the extension part 1324 may be in contact with a top surface of the second plate 1325. According to some embodiments, the extension part 1324 may be coupled to the second plate 1325 by welding or fusion.

The extension part 1324 may be interposed between the edge of the cap-up 131 and the second plate 1325. According to some embodiments, the top surface of the extension part 1324 may be in contact with a bottom surface of the cap-up 131, and a bottom surface of the extension part 1324 may be in contact with a top surface of the second plate 1325.

The second plate 1325 may include a substantially flat coupling part 1326 coupled to the first plate 1321, a second bent part 1327 bent and extending upward at an approximately 90 degrees from the coupling part 1326, and a fixing part 1328 bent and extending inward at approximately 90 degrees from the second bent part 1327.

The second plate 1325 may serve to allow the vent plate 132 to be in close contact with the cap-up 131 or couple or fix the vent plate 132 to the cap-up 131.

According to some embodiments, thicknesses of the coupling part 1326, the second bent part 1327, and the fixing part 1328 may be substantially similar to or the same as each other. The coupling part 1326, the second bent part 1327, and the fixing part 1328 may cover the bottom surface, the side surface, and the top surface of the cap-up 131. According to some embodiments, the coupling part 1326, the second bent part 1327, and the fixing part 1328 may be in close contact with, in contact with, be connected to, or be coupled to the bottom surface, side surface, and top surface of the cap-up 131.

A coupling groove 1326a in which the extension part 1324 of the first plate 1321 is seated may be provided at one side of the coupling part 1326. The coupling groove 1326a may be provided to have a predetermined depth from a top surface of the coupling part 1326. According to some embodiments, a depth of the coupling groove 1326a may be the same as the thickness of the extension part 1324. The top surface of the coupling part 1326 may be located on the same plane as the top surface of the extension part 1324, and a bottom surface of the coupling part 1326 may be located on the same plane as the bottom surface of the central part 1322.

As described above, the vent plate 132 according to the present disclosure may include the first plate 1321 and the second plate 1325, which have rigidities different from each other, to prevent or reduce instances of the portion fixed to the cap-up 131 being deformed while maintaining effective venting properties when the internal pressure of the cylindrical case 110 increases.

The cap-down 133 may be in close contact with, in contact with, connected to, or coupled to the lower portion of the vent plate 132. The cap-down 133 may be electrically connected to the electrode assembly 120 through the positive electrode tab 125. The positive electrode tab 125 of the electrode assembly 120 may be welded to the bottom surface of the cap-down 133. According to some embodiments, the bottom surface of the cap-down 133 may be ultrasonically and/or laser welded to the positive electrode tab 125. According to some embodiments, cap-down 133 may be made of aluminum or an aluminum alloy.

Each of the plurality of through-holes 133a defined in the cap-down 133 may be provided at a position corresponding to the notch 1322a of the first plate 1321. The through-hole 133a may be provided as a passage for the gas generated inside the secondary battery.

A central portion of the cap-down 133 may be in contact with the central part 1322 of the first plate 1321, and an edge of the cap-down 133 may be in close contact with, in contact with, connected to, or coupled to the coupling part 1326 of the second plate 1325. According to some embodiments, the edge of the cap-down 133 may be electrically connected to the coupling part 1326 by welding or fusion.

The insulating gasket 134 may be interposed between the case 110, the vent plate 132, and the cap-down 133. The insulating gasket 134 may cover an outer circumference of each of the vent plate 132 and the cap-down 133. An outer surface of the insulating gasket 134 may be in close contact with the beading part 113 and the crimping part 114, and an inner surface of the insulating gasket 134 may be in close contact with edges of the second plate 1325 and the cap-down 133. According to some embodiments, the insulating gasket 134 may include or be referred to as a sealing gasket, an insulator, or a resin.

The insulating gasket 134 may be made of a resin material such as polyethylene (PE), polypropylene (PP), polyethylene terephthalate (PET), or the like, but the material is not limited here.

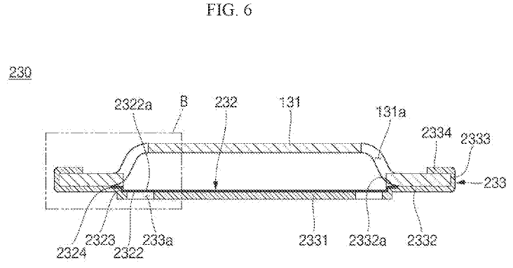

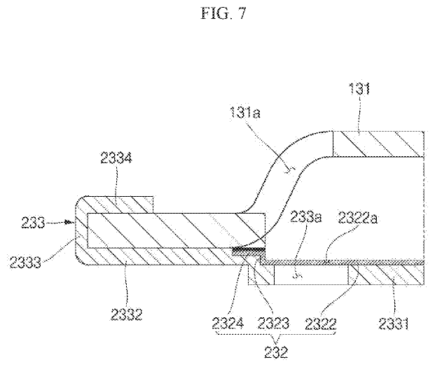

FIG. 6 is a cross-sectional view illustrating a cap assembly according to some embodiments. FIG. 7 is an enlarged cross-sectional view illustrating a portion B of FIG. 6.

Referring to FIG. 6, a cap assembly 230 may include a cap-up 131 provided with a plurality of through-holes 131a, a vent plate 232 installed under the cap-up 131, and a cap-down 233 installed under the vent plate 232 to provide a plurality of through-holes 233a.

A thickness of the vent plate 232 may be provided to be less than that of the cap-down 233. Also, rigidity of the vent plate 232 may be less than that of the cap-down 233.

According to some embodiments, the vent plate 232 and the cap-down 233 may include the same material. According to some embodiments, the vent plate 232 and cap-down 233 may include aluminum. Here, the vent plate 232 may include soft aluminum, and the cap-down 233 may include rigid aluminum. According to some embodiments, the vent plate 232 may include rigid aluminum, and the cap-down 233 may include super-rigid aluminum. For example, the vent plate 232 may include Al 1050, Al 3003, and Al 3005, and the cap-down 233 may include Al 5052 and Al 6000. As described above, when the vent plate 232 and the cap-down 233 are made of the same material, the vent plate 232 and the cap-down 233 may be coupled to each other by welding. According to some embodiments, the vent plate 232 may be ultrasonically and/or laser welded to the cap-down 233.

According to some embodiments, the vent plate 232 and the cap-down 233 may include different materials. For example, the vent plate 232 may include aluminum, and the cap-down 233 may include SUS. As described above, when the vent plate 232 and the cap-down 233 are made of different materials, the vent plate 232 and the cap-down 233 may be coupled to each other by fusion.

The vent plate 232 may have a structure that is substantially similar to or the same as that of the first plate 1321 of FIG. 3. The vent plate 232 may include a substantially flat central part 2322, a first bent part 2323 bent and extending upward at an approximately 90 degrees from the central part 2322, and an extension part 2324 bent and extending outward at approximately 90 degrees from the first bent part 2323. In addition, the central part 2322, the first bent part 2323, and the extension part 2324 may correspond to the central part 1322, the first bent part 1323, and the extension part 1324 of FIG. 3.

The central part 2322 may further include a notch 2322a provided at a predetermined depth on a top surface thereof. The notch 2322a may be provided at a position corresponding to the through-hole 233a of the cap-down 233.

The cap-down 233 may be in close contact with, in contact with, connected to, or coupled to a bottom of the vent plate 232 and an edge of the cap-up 131. The cap-down 233 may include a substantially flat coupling part 2331, a second coupling part 2332 extending outward from the first coupling part 2331, a second bent part 2333 bent and extending upward at an approximately 90 degrees from the second coupling part 2332, and a fixing part 2334 bent and extending inward at approximately 90 degrees from the second bent part 2333. The cap-down 233 may serve to allow the vent plate 232 to be in close contact with the cap-up 131 or couple or fix the vent plate 232 to the cap-up 131.

According to some embodiments, thicknesses of the first coupling part 2331, the second coupling part 2332, the second bent part 2333, and the fixing part 2334 may be substantially similar to or the same as each other. The second coupling part 2332, the second bent part 2333, and the fixing part 2334 may cover the bottom surface, the side surface, and the top surface of the cap-up 131. According to some embodiments, the second coupling part 2332, the second bent part 2333, and the fixing part 2334 may be in close contact with, in contact with, be connected to, or be coupled to the bottom surface, side surface, and top surface of the cap-up 131.

The first coupling part 2331 may be in contact with a bottom surface of the vent plate 232. A plurality of through-holes 233a may be provided in the first coupling part 2331. According to some embodiments, the positive electrode tab 125 of the electrode assembly 120 illustrated in FIG. 2 may be welded to the bottom surface of the first coupling part 2331.

A coupling groove 2332a in which the extension part 2324 of the vent plate 232 is seated may be provided at one side of the second coupling part 2332. According to some embodiments, after being seated in the coupling groove 2332a, the extension part 2324 may be electrically connected to the second coupling part 2332 by welding or fusion.

The coupling groove 2332a may be provided to have a predetermined depth from a top surface of the second coupling part 2332. According to some embodiments, a depth of the coupling groove 2332a may be the same as the thickness of the extension part 2324. The top surface of the second coupling part 2332 and the top surface of the extension part 2324 may be located on the same plane (e.g., coplanar). In addition, the top surface of the second coupling part 2332 and the top surface of the extension part 2324 may be in close contact with, in contact with, connected to, or coupled to the bottom surface of the cap-up 131.

The secondary battery according to some embodiments of the present disclosure may include the vent plate including the first plate and the second plate, which have the rigidities different from each other, to maintain the effective venting properties while preventing or reducing the deformation when the internal pressure of the case increases.

The above-mentioned embodiments are merely illustrative of some embodiments of the secondary battery, and thus, embodiments according to the present invention are not limited to the foregoing embodiments, and also it will be understood by those of ordinary skill in the art that various changes in form and details may be made therein without departing from the spirit and scope of the present invention as defined by the following claims, and their equivalents.

What is claimed is:

1. A secondary battery comprising:
a cylindrical case;
an electrode assembly in the cylindrical case; and
a cap assembly configured to seal the cylindrical case and including a cap-down electrically connected to the electrode assembly, a cap-up coupled to an upper portion of the cap-down, and a vent plate between the cap-down and the cap-up,
wherein the vent plate comprises:
a first plate; and
a second plate coupled to the outside of the first plate,
wherein the first plate has rigidity less than that of the second plate.

2. The secondary battery of claim 1, wherein the first plate has a thickness less than that of the second plate.

3. The secondary battery of claim 1, wherein the first plate and the second plate are made of a same material.

4. The secondary battery of claim 1, wherein the first plate and the second plate are made of materials different from each other.

5. The secondary battery of claim 1, wherein the first plate comprises:
a central part having a notch;
a first bent part extending upward from the central part; and
an extension part extending outward from the first bent part.

6. The secondary battery of claim 5, wherein the second plate comprises:
a coupling part having a coupling groove in which the extension part is seated;
a second bent part extending upward from the coupling part; and
a fixing part extending inward from the second bent part to cover a top surface of the cap-up.

7. The secondary battery of claim 5, wherein the extension part is between a bottom surface of the cap-up and a top surface of the second plate.

8. A secondary battery comprising:
a cylindrical case;
an electrode assembly in the cylindrical case; and
a cap assembly configured to seal the cylindrical case and having a cap-down electrically connected to the electrode assembly, a cap-up coupled to an upper portion of the cap-down, and a vent plate between the cap-down and the cap-up,
wherein the vent plate has rigidity less than that of the cap-down.

9. The secondary battery of claim 8, wherein the vent plate has a thickness less than that of the cap-down.

10. The secondary battery of claim 8, wherein the vent plate and the cap-down are made of a same material.

11. The secondary battery of claim 8, wherein the vent plate and the cap-down are made of materials different from each other, respectively.

12. The secondary battery of claim 8, wherein the vent plate comprises:
a central part having a notch;
a first bent part extending upward from the central part; and
an extension part extending outward from the first bent part.

13. The secondary battery of claim 12, wherein the cap-down comprises:
a first coupling part in contact with the central part and including a plurality of through-holes;
a second coupling part extending outward from the first coupling part and including a coupling groove, in which the extension part is seated;
a second bent part extending upward from the second coupling part; and
a fixing part extending inward from the second bent part to cover a top surface of the cap-up.
